(19) United States
(12) Patent Application Publication
(10) Pub. No.: US 2022/0048394 A1
(43) Pub. Date: Feb. 17, 2022

(54) FREIGHT TRANSPORTATION SYSTEM, CONTROL APPARATUS, AND FREIGHT TRANSPORTATION METHOD

(71) Applicant: Toyota Jidosha Kabushiki Kaisha, Toyota-shi (JP)

(72) Inventors: Shin Sakurada, Toyota-shi (JP); Yasuhiro Baba, Gifu-ken (JP); Shuichi Sawada, Nagoya-shi (JP); Shintaro Matsutani, Kariya-shi (JP); Yurika Tanaka, Yokosuka-shi (JP); Ryosuke Kobayashi, Nagakute-shi (JP); Genshi Kuno, Kasugai-shi (JP); Tomoya Makino, Kariya-shi (JP)

(21) Appl. No.: 17/398,548

(22) Filed: Aug. 10, 2021

(30) Foreign Application Priority Data
Aug. 11, 2020 (JP) 2020-136054

(51) Int. Cl. B60L 9/00; B61B 13/10; B60L 50/90; B65G 43/00

(52) U.S. Cl. CPC B60L 9/00; B61B 13/10; H02J 50/20; B65G 43/00; B60L 50/90

(57) ABSTRACT

A freight transportation system includes a first freight transportation apparatus configured to travel in a first section, a second freight transportation apparatus configured to travel in a second section, a power reception apparatus configured to receive regenerative power from the first freight transportation apparatus that is configured to travel in the first section, a power transmission apparatus configured to transmit the regenerative power to the second freight transportation apparatus that is configured to travel in the second section, and a control apparatus. The control apparatus is configured to perform control so that the second freight transportation apparatus starts traveling from a start point of the second section at a timing when the first freight transportation apparatus starts traveling from a start point of the first section.

### CROSS-REFERENCE TO RELATED APPLICATION

This application claims priority to Japanese Patent Application No. 2020-136054, filed on Aug. 11, 2020, the entire contents of which are incorporated herein by reference.

### TECHNICAL FIELD

The present disclosure relates to a freight transportation system, a control apparatus, and a freight transportation method.

### BACKGROUND

Technology for supplying electric power to transportation apparatuses such as vehicles is known. For example, Patent Literature (PTL) 1 discloses that the electric power generated by regenerative braking operation of the own train is returned to train lines to be consumed by other trains under power.

### CITATION LIST

### Patent Literature

PTL 1: JP 2013-059144 A

### SUMMARY

It is desired to optimize the balance of power supply and demand in technology for supplying regenerative power from a transportation apparatus to other transportation apparatuses. However, in passenger transportation systems, passenger transportation apparatuses cannot start operation until the passengers complete boarding and alighting. Hence, it is difficult to know and control operation start timings, namely, power demand timings, and it is not necessarily easy to optimize the balance of power supply and demand in passenger transportation systems. On the other hand, in freight transportation systems, there is room for improvement with respect to technology for optimizing the balance of power supply and demand.

It would be helpful to improve technology for optimizing the balance of power supply and demand in freight transportation systems.

A freight transportation system according to an embodiment of the present disclosure includes:

a first freight transportation apparatus configured to travel in a first section;

a second freight transportation apparatus configured to travel in a second section;

a power reception apparatus configured to receive regenerative power from the first freight transportation apparatus that is configured to travel in the first section;

a power transmission apparatus configured to transmit the regenerative power to the second freight transportation apparatus that is configured to travel in the second section; and

a control apparatus configured to perform control so that the second freight transportation apparatus starts traveling from a start point of the second section at a timing when the first freight transportation apparatus starts traveling from a start point of the first section.

A control apparatus according to an embodiment of the present disclosure is a control apparatus for a freight transportation system, the freight transportation system including a first freight transportation apparatus configured to travel in a first section, a second freight transportation apparatus configured to travel in a second section, a power reception apparatus configured to receive regenerative power from the first freight transportation apparatus that is configured to travel in the first section, and a power transmission apparatus configured to transmit the regenerative power to the second freight transportation apparatus that is configured to travel in the second section, the control apparatus including a controller configured to perform control so that the second freight transportation apparatus starts traveling from a start point of the second section at a timing when the first freight transportation apparatus starts traveling from a start point of the first section.

A freight transportation method according to an embodiment of the present disclosure is a freight transportation method executed by a freight transportation system, the freight transportation system including a first freight transportation apparatus configured to travel in a first section, a second freight transportation apparatus configured to travel in a second section, a power reception apparatus configured to receive regenerative power from the first freight transportation apparatus that is configured to travel in the first section, a power transmission apparatus configured to transmit the regenerative power to the second freight transportation apparatus that is configured to travel in the second section, and a control apparatus, the freight transportation method including performing control, by the control apparatus, so that the second freight transportation apparatus starts traveling from a start point of the second section at a timing when the first freight transportation apparatus starts traveling from a start point of the first section.

According to an embodiment of the present disclosure, technology for optimizing the balance of power supply and demand in freight transportation systems is improved.

### BRIEF DESCRIPTION OF THE DRAWINGS

In the accompanying drawings:

FIG. 1 is a diagram illustrating a schematic configuration of a freight transportation system according to an embodiment of the present disclosure;

FIG. 2 is a block diagram illustrating a schematic configuration of a server; and

FIG. 3 is a flowchart illustrating operations of the server.

### DETAILED DESCRIPTION

Hereinafter, an embodiment of the present disclosure will be described.

### Summary of Embodiment

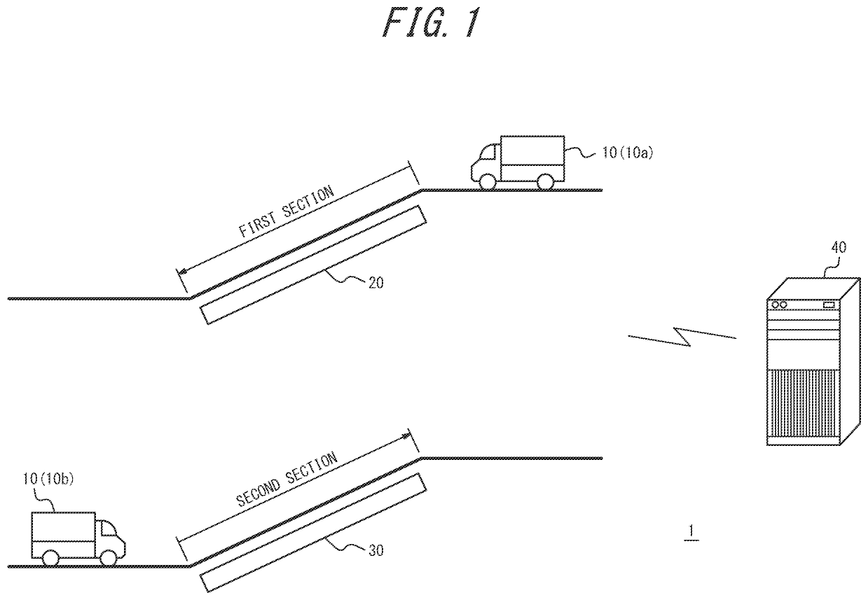

An outline of a freight transportation system 1 according to an embodiment of the present disclosure will be described with reference to FIG. 1. The freight transportation system 1 includes a plurality of freight transportation apparatuses 10, a power reception apparatus 20, a power transmission apparatus 30, and a control apparatus 40. Two freight transportation apparatuses 10a and 10b are illustrated in FIG. 1; however, the number of freight transportation apparatuses 10 included in the freight transportation system 1 may be any number not less than two. The control apparatus 40 is communicably connected to the freight transportation apparatuses 10, the power reception apparatus 20, and the power transmission apparatus 30. The power reception apparatus 20 and the power transmission apparatus 30 are electrically connected.

Each of the freight transportation apparatuses 10 is any apparatus capable of transporting loaded freight by self-propulsion. In the present embodiment, each of the freight transportation apparatuses 10 is a vehicle dedicated to freight transportation. Each of the freight transportation apparatuses 10 may be capable of automated driving such as any one of Level 1 to Level 5 as defined by the Society of Automotive Engineers (SAE), for example.

The power reception apparatus 20 is any apparatus capable of receiving, from a freight transportation apparatus 10, regenerative power generated by regenerative braking of the freight transportation apparatus 10. In the present embodiment, the power reception apparatus 20 is laid along a first section. The first section illustrated in FIG. 1 is a vehicular road that is downhill from the start point to the end point. The power reception apparatus 20 receives regenerative power from the first freight transportation apparatus 10a, which travels in the first section, via radio or wire.

The power transmission apparatus 30 is any apparatus capable of transmitting electric power to a freight transportation apparatus 10. In the present embodiment, the power transmission apparatus 30 is laid along a second section. The second section illustrated in FIG. 1 is a vehicular road that is uphill from the start point to the end point. The power transmission apparatus 30 transmits the regenerative power received by the power reception apparatus 20 to the second freight transportation apparatus 10b, which travels in the second section, via radio or wire. The regenerative power actually received by the power reception apparatus 20 from the first freight transportation apparatus 10a and the regenerative power actually received by the second freight transportation apparatus 10b from the power transmission apparatus 30 may not strictly be equal due to power loss during power transmission. For simplicity of explanation, power loss is ignored in the following. The power transmission apparatus 30 may transmit grid power in addition to the regenerative power to the second freight transportation apparatus 10b.

The control apparatus 40 is, for example, an information processing apparatus such as a computer. The control apparatus 40 controls entire operation of the freight transportation system 1.

First, an outline of the present embodiment will be described, and details thereof will be described later. The control apparatus 40 performs control of operation of the freight transportation apparatuses 10a and 10b so that the second freight transportation apparatus 10b starts traveling from the start point of the second section at the timing when the first freight transportation apparatus 10a starts traveling from the start point of the first section. According to the present embodiment, the timing at which regenerative power is obtained from the first freight transportation apparatus 10a (i.e., the power supply timing) and the timing at which electric power should be supplied to the second freight transportation apparatus 10b (i.e., the power demand timing) are substantially matched; therefore, technology for optimizing the balance of power supply and demand in freight transportation systems is improved.

(Configuration of Control Apparatus)

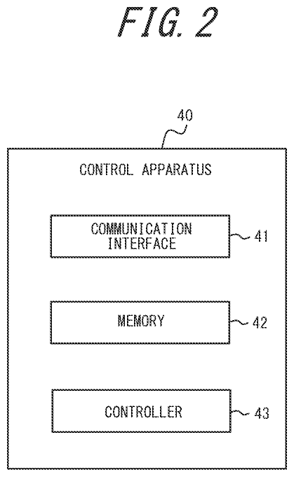

A configuration of the control apparatus 40 will be described in detail. As illustrated in FIG. 2, the control apparatus 40 includes a communication interface 41, a memory 42, and a controller 43.

The communication interface 41 includes at least one communication interface for connecting to a network. The communication interface is compliant with a wired local area network (LAN) standard or a wireless LAN standard, for example, but not limited to these. In the present embodiment, the control apparatus 40 is communicably connected with the freight transportation apparatuses 10, the power reception apparatus 20, and the power transmission apparatus 30 via the communication interface 41 and the network.

The memory 42 includes one or more memories. The memories are semiconductor memories, magnetic memories, optical memories, or the like, for example, but are not limited to these. The memories included in the memory 42 may each function as, for example, a main memory, an auxiliary memory, or a cache memory. The memory 42 stores any information used for operations of the control apparatus 40. For example, the memory 42 may store a system program, an application program, a database, and the like. The information stored in the memory 42 may be updated with, for example, information acquired from the network via the communication interface 41.

The controller 43 includes at least one processor, at least one programmable circuit, at least one dedicated circuit, or a combination of these. The processor is a general purpose processor such as a central processing unit (CPU) or a graphics processing unit (GPU), or a dedicated processor that is dedicated to specific processing, for example, but is not limited to these. The programmable circuit is a field-programmable gate array (FPGA), for example, but is not limited to this. The dedicated circuit is an application specific integrated circuit (ASIC), for example, but is not limited to this. The controller 43 controls the operations of the entire control apparatus 40.

(Flow of Operations of Control Apparatus)

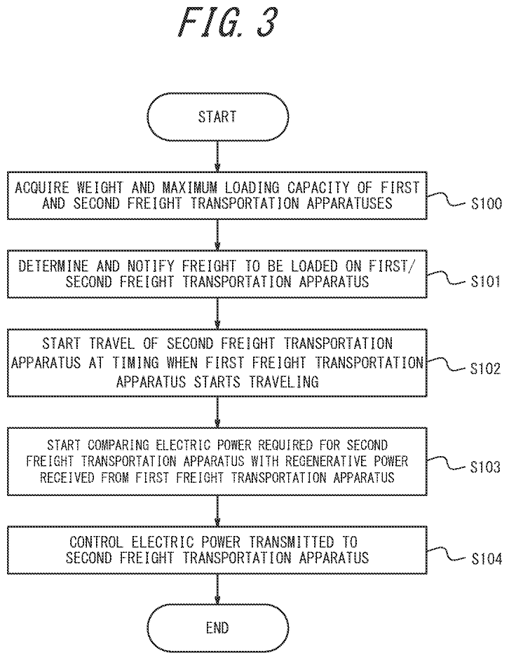

Operations of the control apparatus 40 are described with reference to FIG. 3. For simplicity of explanation, the freight transportation apparatus 10 that enters the first section next will be referred to as a first freight transportation apparatus 10a, and the freight transportation apparatus 10 that enters the second section next will be referred to as a second freight transportation apparatus 10b.

Step S100: The controller 43 of the control apparatus 40 acquires the weight and the maximum loading capacity of each of the first freight transportation apparatus 10a and the second freight transportation apparatus 10b.

Any method can be employed to acquire the weight and the maximum loading capacity. For example, the controller 43 receives a vehicle ID from each of the first freight transportation apparatus 10a and the second freight transportation apparatus 10b via the communication interface 41. The controller 43 acquires the weight and the maximum loading capacity of each of the first freight transportation apparatus 10a and the second freight transportation apparatus 10b using the received vehicle ID as a query from a vehicle database stored in advance in the memory 42. Alternatively, the controller 43 may acquire the weight and the maximum loading capacity by directly receiving the weight and the maximum loading capacity from each of the first freight transportation apparatus 10a and the second freight transportation apparatus 10b. Alternatively, the controller 43 may acquire respective weights of the first freight transportation apparatus 10a and the second freight transportation apparatus 10b measured by respective weight measuring devices provided in advance before the first section and the second section, by receiving the weights from the weight measuring devices. The weight measuring devices may each be provided, for example, in a work area for carrying out freight loading operations.

Step S101: The controller 43 determines freight to be loaded on each of the first freight transportation apparatus 10a and the second freight transportation apparatus 10b so that the total weight of the first freight transportation apparatus 10a with the freight loaded is greater than or equal to the total weight of the second freight transportation apparatus 10b with the freight loaded, and notifies a predetermined apparatus. When the total weight of the first freight transportation apparatus 10a is greater than or equal to the total weight of the second freight transportation apparatus 10b, the probability that the second freight transportation apparatus 10b can travel using only the regenerative power of the first freight transportation apparatus 10a increases.

Any method can be employed to determine the freight to be loaded. For example, the controller 43 acquires the weight of each of a plurality of freight pieces that can be loaded on each of the first freight transportation apparatus 10a and the second freight transportation apparatus 10b. The weight of freight pieces may be acquired, for example, from an external system such as a freight management system. The controller 43 determines, from among the plurality of freight pieces, the freight to be loaded on each of the first freight transportation apparatus 10a and the second freight transportation apparatus 10b so that the total weight of the first freight transportation apparatus 10a is greater than or equal to the total weight of the second freight transportation apparatus 10b, within a range not exceeding the maximum loading capacity of each of the first freight transportation apparatus 10a and the second freight transportation apparatus 10b.

The apparatus to be notified of the determined freight may be freely determined. For example, in a case in which freight loading operations are carried out by workers, terminal apparatuses of the workers, or each of the first freight transportation apparatus 10a and the second freight transportation apparatus 10b may be designated as the apparatus to be notified. Upon receiving notification of the freight to be loaded, the apparatus presents the freight to the workers by screen, audio, or a combination of these to thereby prompt the workers to load the freight. Alternatively, in a case in which freight loading operations are automated, a management apparatus for the loading operations may be designated as the apparatus to be notified. The apparatus to be notified may be set, for example, in response to an operation on the control apparatus 40.

Step S102: The controller 43 performs control of the first freight transportation apparatus 10a and the second freight transportation apparatus 10b so that the second freight transportation apparatus 10b starts traveling from the start point of the second section at the timing when the first freight transportation apparatus 10a starts traveling from the start point of the first section.

Any method can be employed for the control of the first freight transportation apparatus 10a and the second freight transportation apparatus 10b. For example, the controller 43 may transmit an instruction to start traveling to the first freight transportation apparatus 10a, which is located at the start point of the first section, and may transmit an instruction to start traveling to the second freight transportation apparatus 10b, which is located at the start point of the second section. In such a case, each of the first freight transportation apparatus 10a and the second freight transportation apparatus 10b performs automated driving so as to start traveling upon receipt of the corresponding instruction. Alternatively, the controller 43 may transmit a remote driving command to each of the first freight transportation apparatus 10a and the second freight transportation apparatus 10b so that the first freight transportation apparatus 10a and the second freight transportation apparatus 10b start traveling from the start point of the first section and the start point of the second section, respectively, at substantially the same time. In such a case, each of the first freight transportation apparatus 10a and the second freight transportation apparatus 10b travels in accordance with the corresponding command received from the control apparatus 40.

Step S103: The controller 43 starts comparing the electric power required for the second freight transportation apparatus 10b to travel within the second section with the regenerative power received by the power reception apparatus 20 from the first freight transportation apparatus 10a.

In detail, the controller 43 sequentially calculates values of the electric power required for the second freight transportation apparatus 10b to continue traveling based on the total weight of the second freight transportation apparatus 10b including the loaded freight, the slope of the road surface on which the second freight transportation apparatus 10b is located, and the like. The controller 43 sequentially acquires, from the power reception apparatus 20, values of the regenerative power received by the power reception apparatus 20 from the first freight transportation apparatus 10a. The controller 43 sequentially compares the values of the electric power required for the second freight transportation apparatus 10b with the values of the regenerative power acquired from the power reception apparatus 20.

Step S104: The controller 43 controls the electric power transmitted from the power transmission apparatus 30 to the second freight transportation apparatus 10b.

In detail, the controller 43 controls the power transmission apparatus 30 so that target power greater than or equal to the electric power required for the second freight transportation apparatus 10b is transmitted to the second freight transportation apparatus 10b. The value of the target power may be the value of the electric power required for the second freight transportation apparatus 10b, or may be a value obtained by adding a predetermined margin to the electric power required for the second freight transportation apparatus 10b. Specifically, the controller 43 may control the power transmission apparatus 30 to transmit grid power in addition to the regenerative power to the second freight transportation apparatus 10b when the electric power required for the second freight transportation apparatus 10b is greater than the regenerative power. The controller 43 may control the power transmission apparatus 30 to transmit only the regenerative power, or grid power in addition to the regenerative power to the second freight transportation apparatus 10b when the electric power required for the second freight transportation apparatus 10b and the regenerative power are substantially equal. The controller 43 may control the power transmission apparatus 30 to transmit only at least part of the regenerative power, or grid power in addition to the regenerative power to the second freight transportation apparatus 10b when the electric power required for the second freight transportation apparatus 10b is less than the regenerative power.

As described above, in the freight transportation system 1 according to the present embodiment, the control apparatus 40 performs control so that the second freight transportation apparatus 10b starts traveling from the start point of the second section at the timing when the first freight transportation apparatus 10a starts traveling from the start point of the first section.

According to such a configuration, the timing at which regenerative power is obtained from the first freight transportation apparatus 10a (i.e., the power supply timing) and the timing at which electric power should be supplied to the second freight transportation apparatus 10b (i.e., the power demand timing) are substantially matched; therefore, technology for optimizing the balance of power supply and demand in freight transportation systems is improved.

While the present disclosure has been described with reference to the drawings and examples, it should be noted that various modifications and revisions may be implemented by those skilled in the art based on the present disclosure. Accordingly, such modifications and revisions are included within the scope of the present disclosure. For example, functions or the like included in each component, each step, or the like can be rearranged without logical inconsistency, and a plurality of components, steps, or the like can be combined into one or divided.

For example, an embodiment in which each or any of the freight transportation apparatuses 10, the power reception apparatus 20, the power transmission apparatus 30, or a combination of these executes some or all of the operations that are executed by the control apparatus 40 in the embodiment described above can be implemented. An embodiment in which multiple information processing apparatuses that can communicate with each other perform distributed processing of some or all of the operations executed by the control apparatus 40 can be implemented.

In the embodiment described above, each of the first section and the second section may be located in a space that is provided underground and dedicated to freight transportation. For example, in a case in which an underground space dedicated to freight transportation is provided in a smart city, the freight transportation system 1 may be applied in the underground space. According to such a configuration, the need to transport freight above ground is reduced and the energy efficiency of the entire smart city may be improved.

In the embodiment described above, an example is described in which the first section is a vehicular road that is downhill from the start point to the end point, and the second section is a vehicular road that is uphill from the start point to the end point. However, the first section and the second section are not limited to this example. For example, the first section may be an indoor passage sloping downward from the start point to the end point, and the second section may be an indoor passage sloping upward from the start point to the end point. For example, the freight transportation system 1 may be applied in a building such as a high-rise building. According to such a configuration, energy efficiency in Building Energy Management Systems (BEMS) may be improved.

In the embodiment described above, an example in which the freight transportation apparatuses 10 are each a vehicle is described. However, the freight transportation apparatuses 10 are not limited to this example. For example, the freight transportation apparatuses 10 may each be an elevator dedicated to freight transportation. In such a case, the first section is an elevator shaft descending from the start point to the end point, and the second section is an elevator shaft ascending from the start point to the end point. For example, the freight transportation system 1 may be applied in a building such as a high-rise building and freight may be transported in a vertical direction. According to such a configuration, energy efficiency in BEMSs may be improved.

For example, an embodiment in which a general purpose information processing apparatus functions as the control apparatus 40 according to the embodiment described above can also be implemented. Specifically, a program in which processes for realizing the functions of the control apparatus 40 according to the above-described embodiment are written may be stored in a memory of the information processing apparatus, and the program may be read and executed by a processor of the information processing apparatus. Accordingly, the present disclosure can also be implemented as a program executable by a processor, or a non-transitory computer readable medium storing the program.

1. A freight transportation system comprising:
a first freight transportation apparatus configured to travel in a first section;
a second freight transportation apparatus configured to travel in a second section;
a power reception apparatus configured to receive regenerative power from the first freight transportation apparatus that is configured to travel in the first section;
a power transmission apparatus configured to transmit the regenerative power to the second freight transportation apparatus that is configured to travel in the second section; and
a control apparatus configured to perform control so that the second freight transportation apparatus starts traveling from a start point of the second section at a timing when the first freight transportation apparatus starts traveling from a start point of the first section.

2. The freight transportation system according to claim 1, wherein each of the first section and the second section is located in a space that is provided underground and dedicated to freight transportation.

3. The freight transportation system according to claim 1, wherein
the first freight transportation apparatus and the second freight transportation apparatus are each a vehicle,
the first section is a vehicular road that is downhill from the start point to an end point, and
the second section is a vehicular road that is uphill from the start point to an end point.

4. The freight transportation system according to claim 1, wherein
the first freight transportation apparatus and the second freight transportation apparatus are each a vehicle,
the first section is an indoor passage sloping downward from the start point to an end point, and
the second section is an indoor passage sloping upward from the start point to an end point.

5. The freight transportation system according to claim 1, wherein
the first freight transportation apparatus and the second freight transportation apparatus are each an elevator dedicated to freight transportation,
the first section is an elevator shaft descending from the start point to an end point, and
the second section is an elevator shaft ascending from the start point to an end point.

6. The freight transportation system according to claim 1, wherein the control apparatus is configured to determine freight to be loaded on each of the first freight transportation apparatus and the second freight transportation apparatus so that total weight of the first freight transportation apparatus with the freight loaded is greater than or equal to total weight of the second freight transportation apparatus with the freight loaded.

7. The freight transportation system according to claim 1, wherein the control apparatus controls the power transmission apparatus to transmit grid power in addition to the regenerative power to the second freight transportation apparatus when electric power required for the second freight transportation apparatus to travel within the second section is greater than the regenerative power.

8. A control apparatus for a freight transportation system, the freight transportation system including a first freight transportation apparatus configured to travel in a first section, a second freight transportation apparatus configured to travel in a second section, a power reception apparatus configured to receive regenerative power from the first freight transportation apparatus that is configured to travel in the first section, and a power transmission apparatus configured to transmit the regenerative power to the second freight transportation apparatus that is configured to travel in the second section, the control apparatus comprising a controller configured to perform control so that the second freight transportation apparatus starts traveling from a start point of the second section at a timing when the first freight transportation apparatus starts traveling from a start point of the first section.

9. The control apparatus according to claim 8, wherein each of the first section and the second section is located in a space that is provided underground and dedicated to freight transportation.

10. The control apparatus according to claim 8, wherein
the first freight transportation apparatus and the second freight transportation apparatus are each a vehicle,
the first section is a vehicular road that is downhill from the start point to an end point, and
the second section is a vehicular road that is uphill from the start point to an end point.

11. The control apparatus according to claim 8, wherein
the first freight transportation apparatus and the second freight transportation apparatus are each a vehicle,
the first section is an indoor passage sloping downward from the start point to an end point, and
the second section is an indoor passage sloping upward from the start point to an end point.

12. The control apparatus according to claim 8, wherein
the first freight transportation apparatus and the second freight transportation apparatus are each an elevator dedicated to freight transportation,
the first section is an elevator shaft descending from the start point to an end point, and
the second section is an elevator shaft ascending from the start point to an end point.

13. The control apparatus according to claim 8, wherein the controller is configured to determine freight to be loaded on each of the first freight transportation apparatus and the second freight transportation apparatus so that weight of the first freight transportation apparatus with the freight loaded and weight of the second freight transportation apparatus with the freight loaded are substantially equal.

14. The control apparatus according to claim 8, wherein the controller controls the power transmission apparatus to transmit grid power in addition to the regenerative power to the second freight transportation apparatus upon determining that electrical energy required for the second freight transportation apparatus to travel from the start point to an end point of the second section is greater than regenerative electrical energy to be transmitted to the power reception apparatus while the first freight transportation apparatus travels from the start point to an end point of the first section.

15. A freight transportation method executed by a freight transportation system, the freight transportation system including a first freight transportation apparatus configured to travel in a first section, a second freight transportation apparatus configured to travel in a second section, a power reception apparatus configured to receive regenerative power from the first freight transportation apparatus that is configured to travel in the first section, a power transmission apparatus configured to transmit the regenerative power to the second freight transportation apparatus that is configured to travel in the second section, and a control apparatus, the freight transportation method comprising performing control, by the control apparatus, so that the second freight transportation apparatus starts traveling from a start point of the second section at a timing when the first freight transportation apparatus starts traveling from a start point of the first section.

16. The freight transportation method according to claim 15, wherein each of the first section and the second section is located in a space that is provided underground and dedicated to freight transportation.

17. The freight transportation method according to claim 15, wherein
the first freight transportation apparatus and the second freight transportation apparatus are each a vehicle,
the first section is a vehicular road that is downhill from the start point to an end point, and
the second section is a vehicular road that is uphill from the start point to an end point.

18. The freight transportation method according to claim 15, wherein
the first freight transportation apparatus and the second freight transportation apparatus are each a vehicle,
the first section is an indoor passage sloping downward from the start point to an end point, and
the second section is an indoor passage sloping upward from the start point to an end point.

19. The freight transportation method according to claim 15, further comprising determining, by the control apparatus, freight to be loaded on each of the first freight transportation apparatus and the second freight transportation apparatus so that weight of the first freight transportation apparatus with the freight loaded and weight of the second freight transportation apparatus with the freight loaded are substantially equal.

20. The freight transportation method according to claim 15, further comprising controlling, by the control apparatus, the power transmission apparatus to transmit grid power in addition to the regenerative power to the second freight transportation apparatus upon determining that electrical energy required for the second freight transportation apparatus to travel from the start point to an end point of the second section is greater than regenerative electrical energy to be transmitted to the power reception apparatus while the first freight transportation apparatus travels from the start point to an end point of the first section.
